(19) United States
(12) Patent Application Publication
(10) Pub. No.: US 2008/0180369 A1
(43) Pub. Date: Jul. 31, 2008

(54) Method for Driving a Display Panel and Related Apparatus

(75) Inventors: Chung-Ming Chiu, Tao-Yuan Hsien (TW); Cheng-His Pan, Kao-Hsiung Hsien (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: TPO DISPLAYS CORP., Miao-Li County (TW)

(21) Appl. No.: 11/627,503

(22) Filed: Jan. 26, 2007

(51) Int. Cl. G09G 3/36

(52) U.S. Cl. 345/87

(57) ABSTRACT

A driving method includes writing data with opposite polarities simultaneously into a first pixel unit of the display panel via a first demultiplexer and into a second pixel unit adjacent to the first pixel unit via a second demultiplexer when displaying a first frame, wherein the first pixel unit and the second pixel unit are coupled to a first gate line. Adjacent pixel units of the same gate line that receive data from the data driver via different demultiplexers are accessed simultaneously.

### BACKGROUND OF THE INVENTION

1. Field of the Invention

The present invention relates to a method for driving a display panel and related apparatus, and more particularly, to a method for driving a display panel and related apparatus capable of reducing mura.

2. Description of the Prior Art

Liquid crystal display (LCDs) are flat panel displays with low power consumption that have been widely used in various products, including personal digital assistants (PDAs), mobile phones, notebook/desktop computers, and communication terminals. Active matrix type LCD devices have an active element (e.g. thin-film transistor, TFT) on a per-pixel basis for performing switching operations; and are widely used due to their superior properties in visible angles, contrast, and response time.

In general, an LCD device controls light transmittance of liquid crystal material in accordance with a video signal so that a picture corresponding to the video signal can be displayed on the LCD panel. The LCD device includes an LCD panel having liquid crystal cells arranged in a matrix shape, and driving circuits for driving the LCD panel. In the LCD panel, a plurality of data lines and a plurality of gate lines are intersected, and pixel driving TFT switches are provided at respective intersected portions. The driving circuits of the LCD include a source driver for supplying data signals to the data lines of the LCD panel, and a gate driver for supplying scanning pulses to the LCD panel. With increasing demands for larger display screen sizes and high-resolution applications, there is a tendency toward increased number of pixels and data lines. Therefore, an LCD device may include demultiplexers provided between the source driver and the data lines in order to distribute outputs of the source driver into the data lines. The demultiplexers reduce the number of the outputs of the source driver so as to simplify the circuit layouts and to reduce the number of data input terminals of the LCD panel.

There are three driving methods used for LCD devices: the frame-inversion method, the line-inversion method, and the dot-inversion method. In the dot-inversion system, data signals having opposite polarities are applied to adjacent liquid crystal cells. The line-inversion driving method includes column-inversion and row-inversion. When driving an LCD device based on the column-inversion method, the polarities of data applied to each liquid crystal cell are inverted with respect to alternating gate lines. When driving an LCD device based on the row-inversion method, the polarities of data applied to each liquid crystal cell are inverted with respect to alternating data lines. In the frame-inversion method, the polarities of data applied to each liquid crystal cell are inverted with respect to alternating display frames. Among these three LCD panel driving methods, the dot-inversion system allows a certain liquid crystal cell to have a data signal having a polarity contrary to data signals applied to its adjacent liquid crystal cells in the vertical and horizontal directions, thereby provides a picture having a better quality than the frame- and line-inversion systems. In light of this advantage, recently LCD panels have mainly used the dot-inversion driving method or system.

FIG. 1 is a diagram of a prior art LCD device 10 for illustrating a prior art dot-inversion system. The LCD device 10 includes a gate driver 11, a source driver 12, a control circuit 13, an LCD panel 15, and demultiplexers DUX₁ and DUX₂. For ease of explanation, only six data lines DL₁-DL₆, gate lines GL₁-GLₙ and a plurality of pixel units P₁₁-P₆ₙ are illustrated in the LCD panel 15 in FIG. 1. The demultiplexer DUX₁ includes switches SW₁-SW₃ and the demultiplexer DUX₂ includes switches SW₄-SW₆. Each of the pixel units P₁₁-P₆ₙ includes a thin film transistor switch TFT, a storage capacitor Cs, and a cell capacitor C_{LC}. Each storage capacitor Cs and each cell capacitor C_{LC} are coupled to voltage sources V_{cs} and V_{com}, respectively. The gate driver 11 sends scan signals to the gate line GL₁-GLₙ for turning on corresponding thin film transistor switches TFT. The source driver 12 supplies data signals to the data lines DL₁-DL₃ via the switches SW₁-SW₃ of the demultiplexer DUX₁ and to the data lines DL₄-DL₆ via the switches SW₄-SW₆ of the demultiplexer DUX₂, respectively. The control circuit 13 sends control signals CKH₁-CKH₃ to the switches SW₁-SW₆ of the demultiplexers DUX₁ and DUX₂ for turning on the switches SW₁-SW₆.

FIG. 2 shows a timing chart 20 of control signals CKH₁-CKH₃ provided by the control circuit 13 to the switches SW₁-SW₆. First, the control signal CKH₁ turns on the switches SW₁ and SW₄ simultaneously, and data is written into the pixel units P₁ and P₄ via the data lines DL₁ and DL₄ respectively. Next, the control signal CKH₂ turns on the switches SW₂ and SW₅ simultaneously, and data is written into the pixel units P₂ and P₅ via the data lines DL₂ and DL₅ respectively. Finally, the control signal CKH₃ turns on the switches SW₃ and SW₆ simultaneously and data is written into the pixel units P3 and P6 via the data lines DL₃ and DL₆ respectively. Signs “+” (when the pixel voltage minus the voltage V_{com} is positive) and “−” (when the pixel voltage minus the voltage V_{com} is negative) in FIG. 2 indicate the polarity of data written into each pixel unit when a corresponding switch is turned on.

Since each pixel unit includes a storage capacitor Cs and a cell capacitor C_{LC}, stray capacitance exists between adjacent pixel units. In the prior art driving method, adjacent pixel units P₃ and P₄ receiving data from the source driver 12 via different demultiplexers are not accessed simultaneously. Data is first written into the pixel unit P₄ in response to the control signal CKH₁. When control signal CHK₃ turns on the switches SW₃ and SW₆, data written into the pixel units P₃ is influenced by the data already stored in the adjacent pixel units P₄ due the stray capacitance. This phenomenon is known as the cross-talk that results in irregularities (mura) generated in a nearby effective display region of the LCD device 10. The mura phenomena largely reduce the display quality of the display panel 15.

### SUMMARY OF THE INVENTION

The claimed invention provides a method for driving a display panel comprising when displaying a first frame, writing data with a first polarity into a first pixel unit of the display panel via a first demultiplexer and writing data with a second polarity into a second pixel unit adjacent to the first pixel unit via a second demultiplexer simultaneously, wherein the first and second pixel units are coupled to a first gate line, and the first polarity is opposite to the second polarity.

The claimed invention further provides A system for displaying images comprising a gate line, a first pixel unit coupled to the gate line, a second pixel unit adjacent to the first pixel unit and coupled to the gate line, a first demultiplexer coupled to the first pixel unit, a second demultiplexer coupled to the second pixel unit, and means for writing data with a first polarity into the first pixel unit via the first demultiplexer and writing data with a second polarity into the second pixel unit via the second demultiplexer simultaneously when displaying a first frame, wherein the first polarity is opposite to the second polarity.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a prior art LCD device.

FIG. 2 id a timing chart of control signals used for driving the LCD device in FIG. 1.

FIG. 3 is a diagram of an LCD device according to the present invention.

FIG. 4 and FIG. 5 are timing charts of control signals used for driving the LCD device in FIG. 3.

FIG. 6 is a schematic diagram showing the polarities of data written into the pixel units according to a first embodiment of the present invention.

FIG. 7 is a schematic diagram showing the polarities of data written into the pixel units according to a second embodiment of the present invention.

FIG. 8 and FIG. 9 are timing charts of control signals used for driving the LCD device in FIG. 3.

FIG. 10 is a schematic diagram showing the polarities of data written into the pixel units according to a third embodiment of the present invention.

FIG. 11 is a schematic diagram showing the polarities of data written into the pixel units according to a fourth embodiment of the present invention.

FIG. 12 is a diagram of an LCD device according to the present invention.

FIG. 13-FIG. 16 are timing charts of control signals used for driving the LCD device in FIG. 12.

FIG. 17 is a schematic diagram showing the polarities of data written into the pixel units according to a fifth embodiment of the present invention.

FIG. 18 is a schematic diagram showing the polarities of data written into the pixel units according to a sixth embodiment of the present invention.

FIG. 19 is a schematic diagram showing the polarities of data written into the pixel units according to a seventh embodiment of the present invention.

FIG. 20 is a schematic diagram showing the polarities of data written into the pixel units according to an eighth embodiment of the present invention.

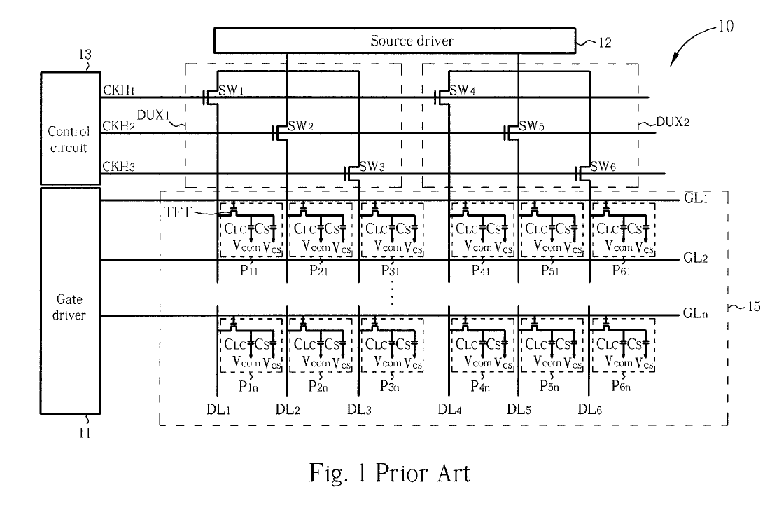

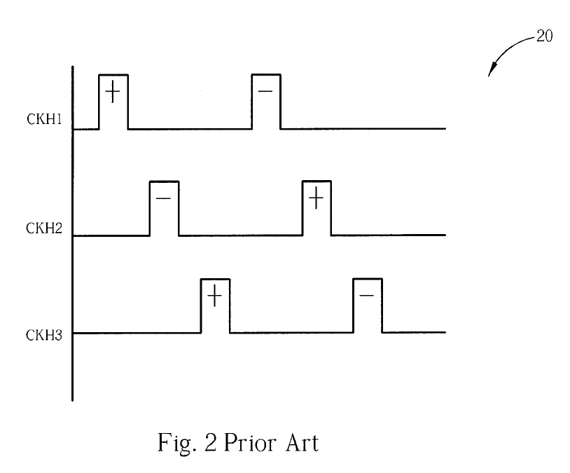

### DETAILED DESCRIPTION

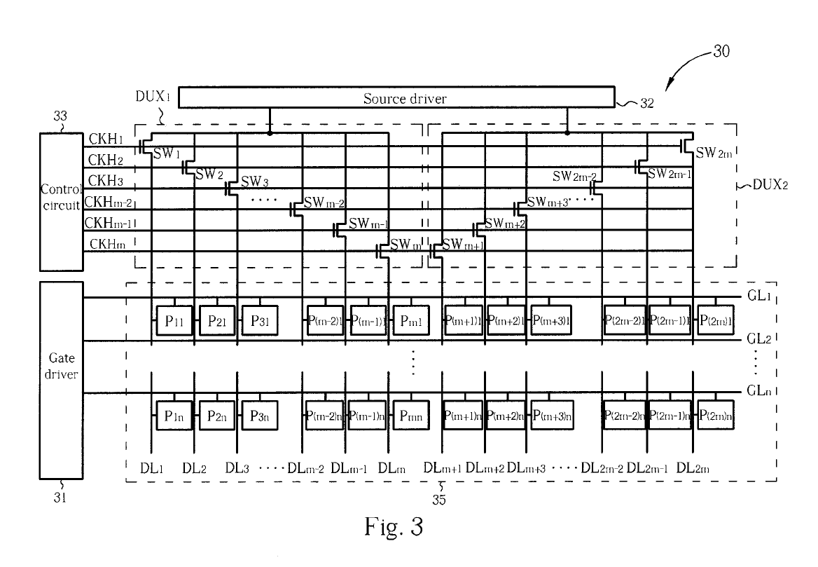

FIG. 3 shows a diagram of an LCD device 30 for illustrating a dot-inversion driving method according to the present invention. The LCD device 30 includes a gate driver 31, a source driver 32, a control circuit 33, an LCD panel 35, and demultiplexers DUX₁ and DUX₂. A plurality of data lines DL₁-DL₂ₘ, a plurality of gate lines GL₁-GLₙ, and a plurality of pixel units P₁₁-P₍₂ₘ₎ₙ are disposed on the LCD panel 35. The demultiplexer DUX₁ includes switches SW₁-SWₘ and the demultiplexer DUX₂ includes switches SWₘ₊₁-SW₂ₘ. The gate driver 31 sends scan signals to the gate line GL₁-GLₙ for turning on corresponding thin film transistor switches. The source driver 32 supplies data signals to the data lines DL₁-DLₘ via the switches SW₁-SWₘ of the demultiplexer DUX₁ and to the data lines DLₘ₊₁-DL₂ₘ via the switches SWₘ₊₁-SW₂ₘ of the demultiplexer DUX₂, respectively. The control circuit 33 sends control signals CKH₁-CKHₘ to the switches SW₁-SWₘ of the demultiplexers DUX₁ and DUX₂ for turning on the switches SW₁-SW₂ₘ. As shown in FIG. 3, each control signal turns on a switch coupled to the demultiplexer DUX₁ and a switch coupled to the demultiplexer DUX₂ simultaneously.

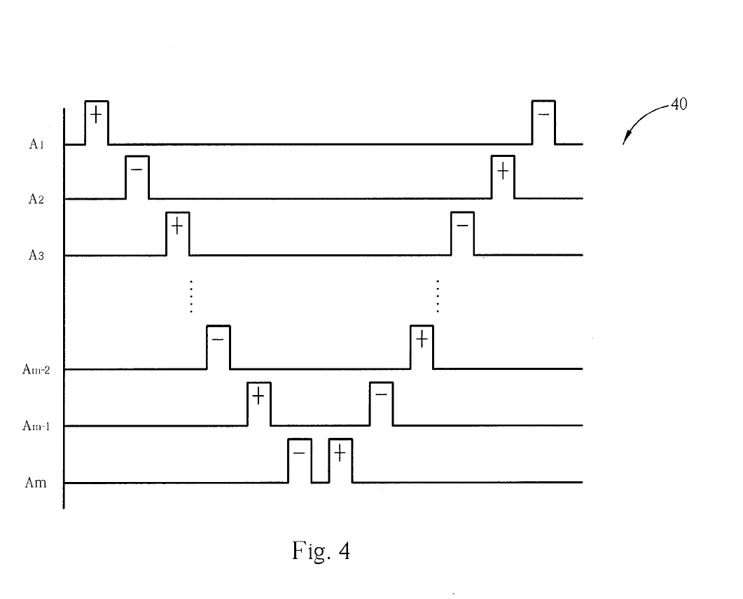

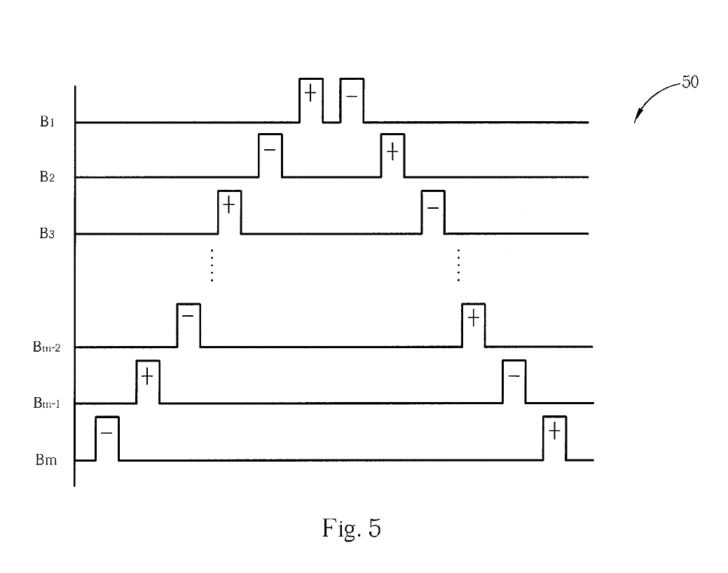

References are made to FIG. 4 and FIG. 5 for diagrams illustrating driving methods according to the present invention. FIG. 4 shows a timing chart 40 including scan pulses A₁-Aₘ, and FIG. 5 shows a timing chart 50 including scan pulses B₁-Bₘ. Signs “+” (when the pixel voltage minus the voltage V_{com} is positive) and “−” (when the pixel voltage minus the voltage V_{com} is negative) in FIG. 4 and FIG. 5 indicate the polarity of data written into each pixel unit when a corresponding switch is turned on. In a first embodiment of the present invention, the scan pulses A₁-Aₘ illustrated in the timing chart 40 are applied to the switches SW₁-SW₂ₘ when the pixel units coupled to the odd-numbered gate lines (GL₁, GL₃, . . . GLₙ₋₁) are being accessed, and the scan pulses B₁-Bₘ illustrated in the timing chart 50 are applied to the switches SW₁-SW₂ₘ when the pixel units coupled to the even-numbered gate lines (GL₂, GL₄, . . . GLₙ) are being accessed. Each scan pulse turns on a switch coupled to the demultiplexer DUX₁ and a switch coupled to the demultiplexer DUX₂ simultaneously. Herein the gate line GL₁ is used as an example of the odd-numbered gate lines. Each of the control signals CKH₁-CKHₘ (using scan pulses A₁-Aₘ respectively) turns on a switch in the demultiplexer DUX₁ and a switch in the demultiplexer DUX₂ simultaneously, wherein the switches in the demultiplexer DUX₁ are turned on in a sequence from SW₁ to SWₘ sequentially, and the switches in the demultiplexer DUX₂ are turned on in a sequence from SW₂ₘ to SWₘ₊₁ sequentially. Similarly, herein the gate line GL₂ is used as an example of the even-numbered gate lines. Each of the control signals CKH₁-CKHₘ (using scan pulses B₁-Bₘ respectively) turns on a switch in the demultiplexer DUX₁ and a switch in the demultiplexer DUX₂ simultaneously, wherein the switches in the demultiplexer DUX₁ are turned on in a sequence from SWₘ to SW₁ sequentially, and the switches in the demultiplexers DUX₂ are turned on in a sequence from SWₘ₊₁ to SW₂ₘ sequentially.

In a second embodiment of the present invention, the scan pulses B₁-Bₘ illustrated in the timing chart 50 are applied to the switches SW₁-SW₂ₘ when the pixel units coupled to the odd-numbered gate lines (GL₁, GL₃, . . . GLₙ₋₁) are being accessed, and the scan pulses A₁-Aₘ illustrated in the timing chart 40 are applied to the switches SW₁-SW₂ₘ when the pixel units coupled to the even-numbered gate lines (GL₂, GL₄, . . . GLₙ) are being accessed. Each scan pulse turns on a switch coupled to the demultiplexer DUX₁ and a switch coupled to the demultiplexer DUX₂ simultaneously. Herein the gate line GL₁ is also used as an example of the odd-numbered gate lines. Each of the control signals CKH₁-CKHₘ (using the scan pulses B₁-Bₘ respectively) turns on a switch in the demultiplexer DUX₁ and a switch in the demultiplexer DUX₂ simultaneously, wherein the switches in the demultiplexer DUX₁ are turned on in a sequence from SWₘ to SW₁ sequentially, and the switches in the demultiplexers DUX₂ are turned on in a sequence from SWₘ₊₁ to SW₂ₘ sequentially. Similarly, herein the gate line GL₂ is also used as an example of even-numbered gate lines. Each of the control signal CKH₁-CKHₘ (using scan pulses A₁-Aₘ respectively) turns on a switch in the demultiplexers DUX₁ and a switch in the demultiplexers DUX₂ simultaneously, wherein the switches in the demultiplexers DUX₁ are turned on in a sequence from SW₁ to SWₘ sequentially, and the switches in the demultiplexers DUX2 are turned on in a sequence from SW₂ₘ to SWₘ₊₁ sequentially.

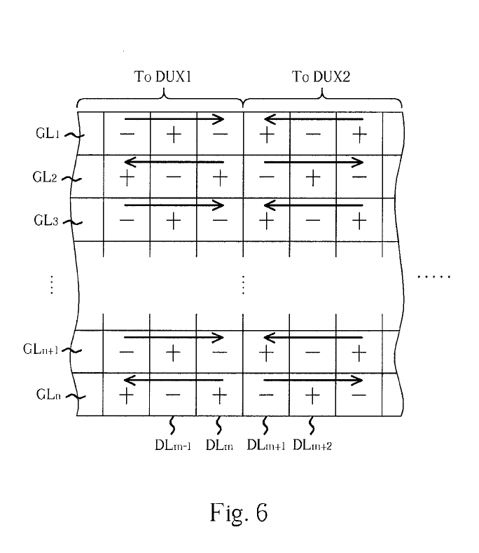

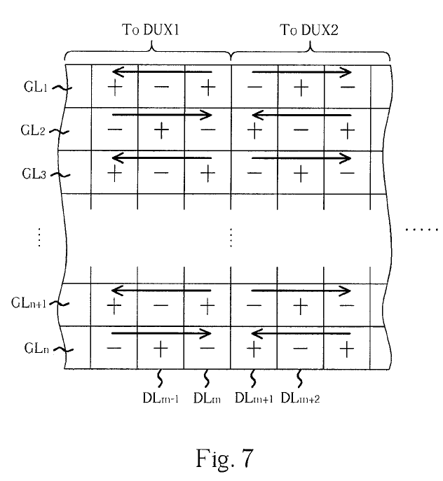

FIG. 6 and FIG. 7 are schematic diagrams showing the polarities of data written into the pixel units of the LCD device 30 in the first and second embodiments respectively. The arrows in FIGS. 6 and 7 indicate the scan directions of each gate line. In the first and second embodiments of the present invention, each pixel unit contains data with a polarity opposite to that of adjacent pixel units in the vertical and horizontal directions. Also, adjacent pixel units receiving data from the data driver 32 via different demultiplexers (e.g.: the pixel units Pₘ₁ of the data line DLₘ and the pixel units P₍ₘ₊₁₎₁ of the data line DLₘ₊₁) are accessed simultaneously. Therefore, stray capacitance existing between these adjacent pixel units do not influence data written into the pixel units. As a result, the present invention can reduce mura effect and thus provides high display quality.

In the first embodiment of the present invention, the scan pulses A₁-Aₘ and the scan pulses B₁-Bₘ are applied when accessing the pixel units coupled to the odd- and even-numbered gate lines respectively during each frame period. In the second embodiment of the present invention, the scan pulses A₁-Aₘ and the scan pulses B₁-Bₘ are applied when accessing the pixel units coupled to the even- and odd-numbered gate lines respectively during each frame period. However, different scan pulses can be applied when accessing a same gate line during different frame periods.

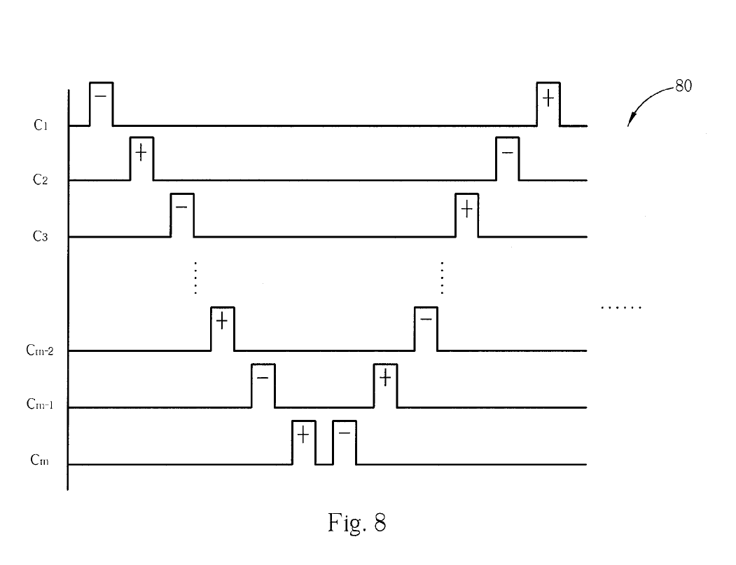

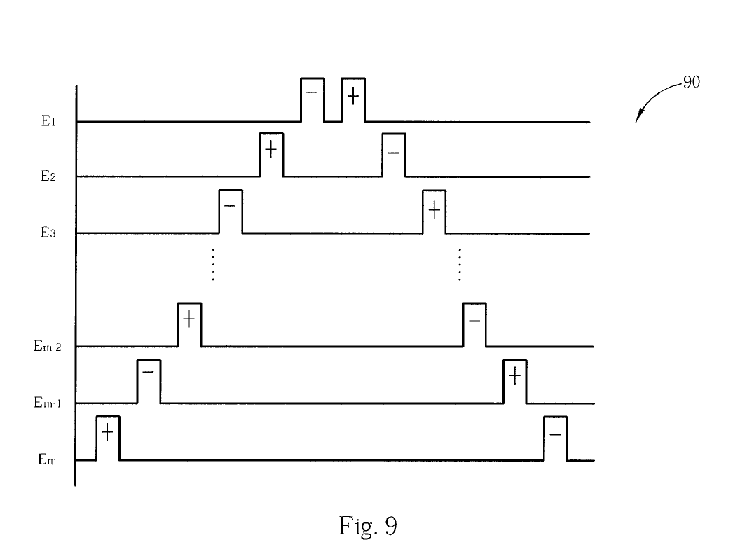

Reference is made to FIG. 8 and FIG. 9 for timing charts 80 and 90 including scan pulses C₁-Cₘ and E₁-Eₘ respectively. Signs “+” (when the pixel voltage minus the voltage V_{com} is positive) and “−” (when the pixel voltage minus the voltage V_{com} is negative) in FIGS. 8 and 9 indicate the polarity of data written into each pixel unit when a corresponding switch is turned on. The scan pulses C₁-Cₘ of the timing chart 80 provide the same scan sequence as the scan pulses A₁-Aₘ of the timing chart 40, but data written into each pixel unit using the scan pulses C₁-Cₘ has opposite polarity to data written into each corresponding pixel unit using the scan pulses A₁-Aₘ. Similarly, the scan pulses E₁-Eₘ of the timing chart 90 have the same scan sequence as the scan pulses B₁-Bₘ of the timing chart 50, but data written into each pixel unit using the scan pulses E₁-Eₘ has opposite polarity to data written into each corresponding pixel unit using the scan pulses B₁-Bₘ. In a third embodiment of the present invention, the scan pulses A₁-Aₘ and the scan pulses B₁-Bₘ are applied when accessing the pixel units coupled to the odd- and even-numbered gate lines respectively during each odd-numbered frame period, and the scan pulses E₁-Eₘ and the scan pulses C₁-Cₘ are applied when accessing the pixel units coupled to the odd- and even-numbered gate lines respectively during each even-numbered frame period. In a fourth embodiment of the present invention, the scan pulses B₁-Bₘ and the scan pulses A₁-Aₘ are applied when accessing the pixel units coupled to the odd- and even-numbered gate lines respectively during each odd-numbered frame period, and the scan pulses C₁-Cₘ and the scan pulses E₁-Eₘ are applied when accessing the pixel units coupled to the odd- and even-numbered gate lines respectively during each even-numbered frame period. In the third and fourth embodiments of the present invention, pixel units of a same gate line are scanned in different directions with respect to alternating frame periods.

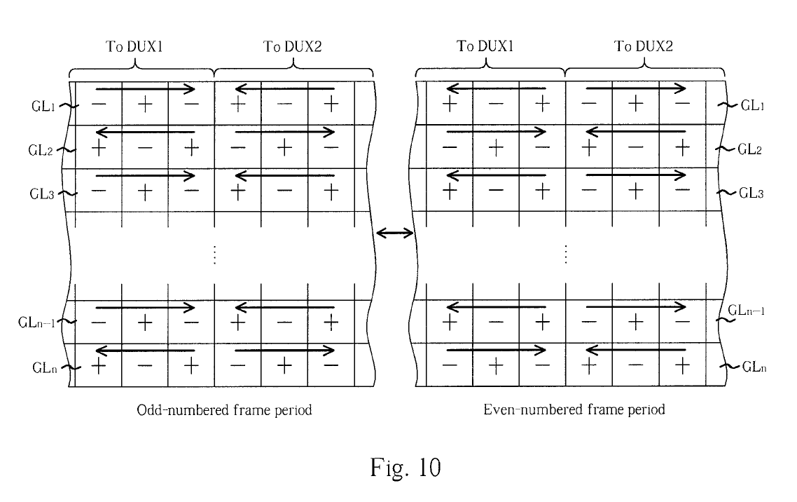

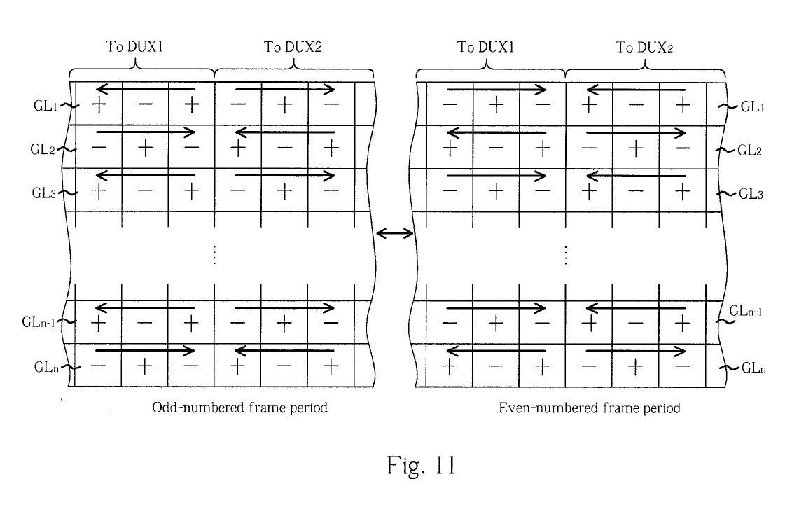

FIG. 10 and FIG. 11 are schematic diagrams showing the polarities of data written into the pixel units of the LCD device 30 in the third and fourth embodiments respectively. The arrows in the figures indicate the scan directions of each gate line. In the third and fourth embodiments of the present invention, each pixel unit contains data with a polarity opposite to that of adjacent pixel units in the vertical and horizontal directions. Also, adjacent pixel units receiving data from the data driver 32 via different demultiplexers (e.g.: the pixel units Pₘ₁ of the data line DLₘ and the pixel units P₍ₘ₊₁₎₁ of the data line DLₘ₊₁) are accessed simultaneously. Therefore, stray capacitance existing between these adjacent pixels units do not influence data written into the pixels. In addition, the scan direction of the same gate line changes with respect to alternating frame periods, which further reduces mura phenomenon in the LCD device 30.

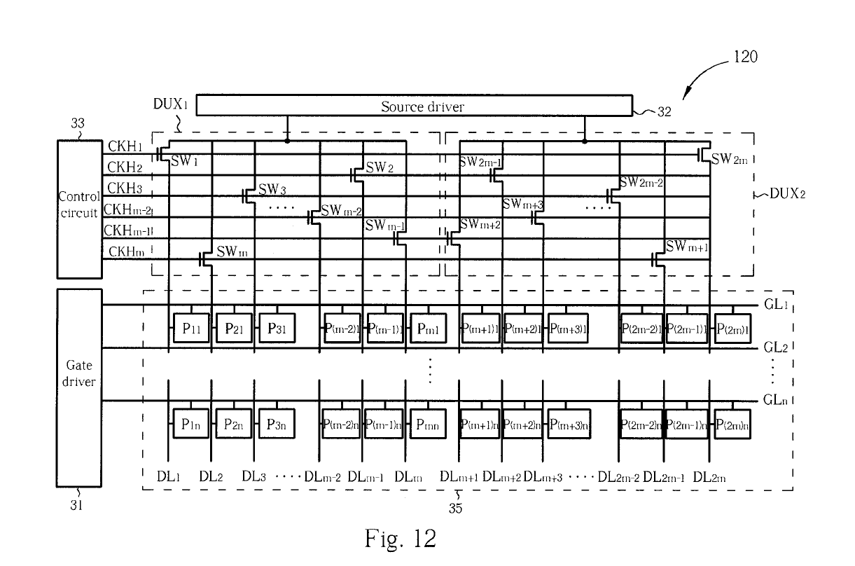

FIG. 12 shows a diagram of an LCD device 120 for illustrating a dot-inversion driving method according to the present invention. The LCD device 120 also includes a gate driver 31, a source driver 32, a control circuit 33, an LCD panel 35, and demultiplexers DUX₁ and DUX₂. The LCD device 120 differs from the LCD device 30 in that the switches of the demultiplexers have different circuit layouts. The switches of the demultiplexers in the LCD device 30 have a regular circuit layout, while the switches of the demultiplexers in the LCD device 120 have an irregular circuit layout.

When driving the LCD device 30 based on the first through fourth embodiments of the present invention, data generated by the source driver 32 is sequentially written into the pixel units of the data lines DL₁-DLₘ when the switches in the demultiplexer DUX₁ are turned on in a sequence SW₁-SWₘ, or sequentially written into the pixel units of the data lines DLₘ-DL₁ when the switches in the demultiplexer DUX₁ are turned on in a sequence SWₘ-SW₁ due to its regular circuit layout. Also, data generated by the source driver 32 is sequentially written into the pixel units of the data lines DLₘ₊₁-DL₂ₘ when the switches in the demultiplexer DUX₂ are turned on in a sequence SWₘ₊₁-SW₂ₘ, or sequentially written into the pixel units of the data lines DLₘ-DL₁ when the switches in the demultiplexer DUX₂ are turned on in a sequence SW₂ₘ-SWₘ₊₁ due to its regular circuit layout. However, due to the irregular circuit layout of the LCD device 120, data generated by the source driver 32 is sequentially written into the data lines in a different sequence.

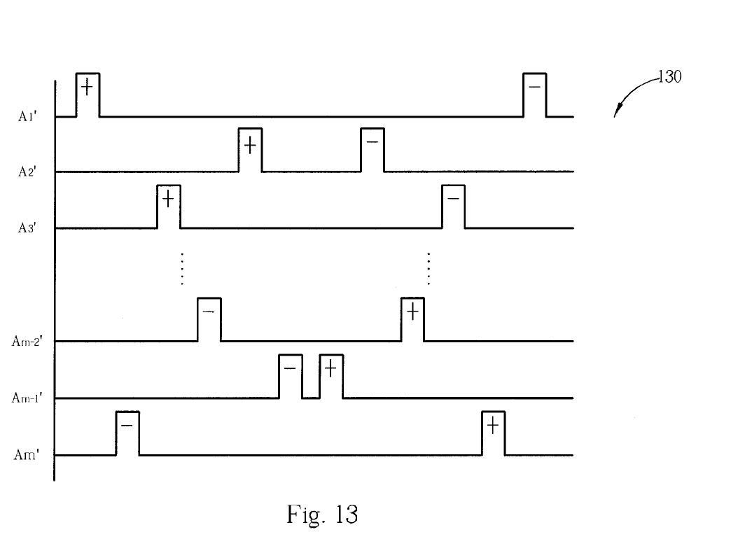

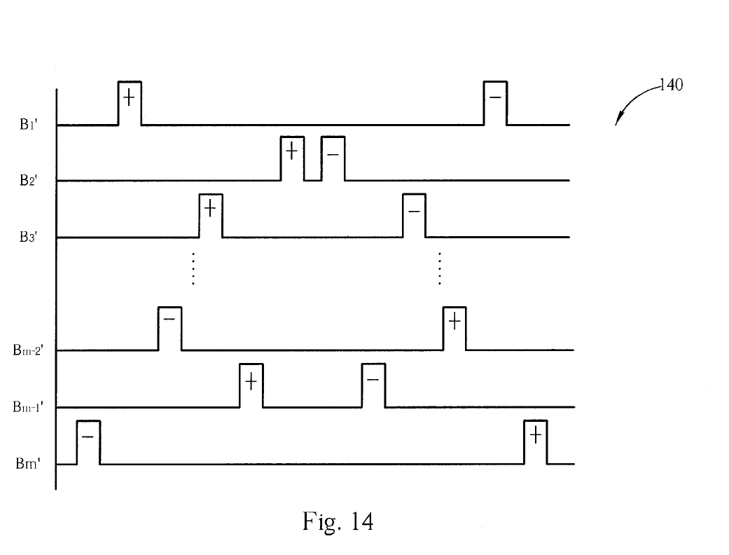

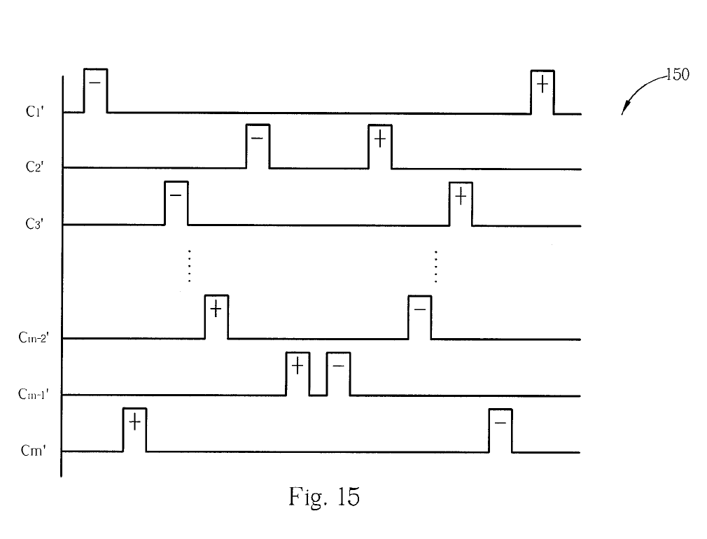

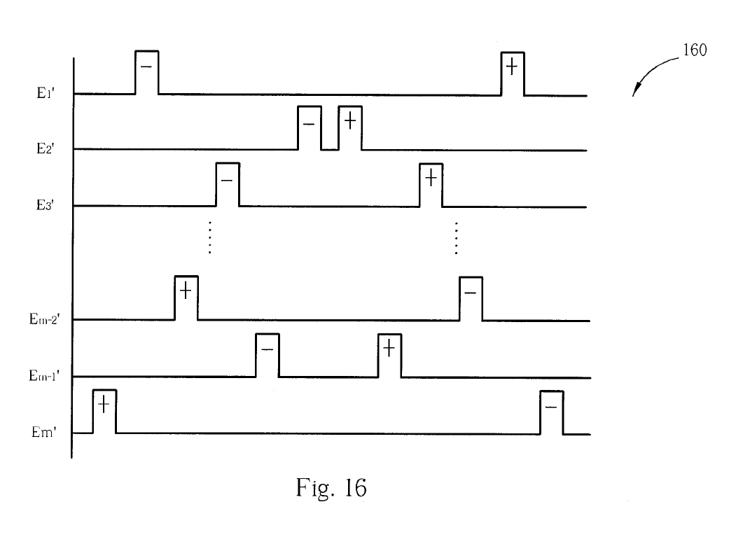

Reference is made to FIGS. 13-16 for illustrating methods for driving the LCD device 120 according to the present invention. Timing charts 130-160 of FIGS. 13-16 include scan pulses A₁′-Aₘ′, B₁′-Bₘ′, C₁′-Cₘ′ and E₁′-Eₘ′ respectively. Signs “+” (when the pixel voltage minus the voltage V_{com} is positive) and “−” (when the pixel voltage minus the voltage V_{com} is negative) in FIGS. 13-16 indicate the polarity of data written into each pixel unit when a corresponding switch is turned on. The scan pulses C₁′-Cₘ′ of the timing chart 150 provide the same scan sequence as the scan pulses A₁′-Aₘ′ of the timing chart 130, but data written into each pixel unit using the scan pulses C₁′-Cₘ′ has opposite polarity to data written into each corresponding pixel unit using the scan pulses A₁′-Aₘ′. Similarly, the scan pulses E₁′-Eₘ′ of the timing chart 160 have the same scan sequence as the scan pulses B₁′-Bₘ′ of the timing chart 140, but data written into each pixel unit using the scan pulses E₁′-Eₘ′ has opposite polarity to data written into each corresponding pixel unit using the scan pulses B₁′-Bₘ′. In a fifth embodiment of the present invention, the scan pulses A₁′-Aₘ′ and the scan pulses B₁′-Bₘ′ are respectively applied when accessing the pixel units coupled to the odd-number gate lines (GL₁□GL₃□ . . . □GLₙ₋₁) and even-numbered gate lines (GL₂□GL₄□ . . . □GLₙ) of the LCD device 120. Each scan pulse turns on a switch coupled to the demultiplexer DUX₁ and a switch coupled to the demultiplexer DUX₂ simultaneously. In a sixth embodiment of the present invention, the scan pulses B₁′-Bₘ′ and the scan pulses A₁′-Aₘ′ are respectively applied when accessing the pixel units coupled to the odd-number gate lines and even-numbered gate lines of the LCD device 120. Each scan pulse turns on a switch coupled to the demultiplexer DUX₁ and a switch coupled to the demultiplexer DUX₂ simultaneously.

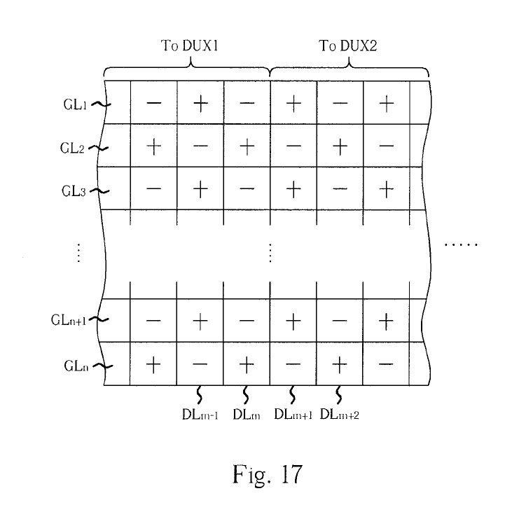

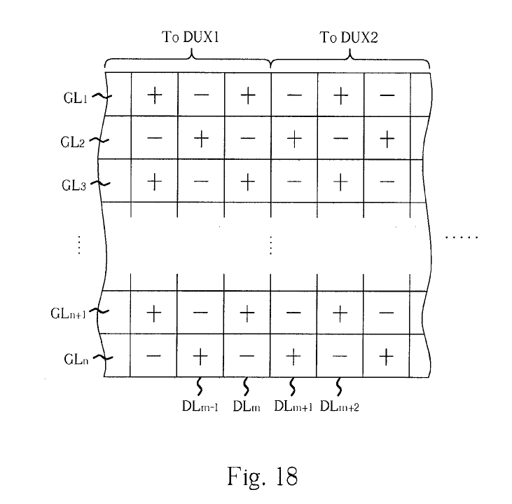

FIG. 17 and FIG. 18 are schematic diagrams showing the polarities of data written into the pixel units of the LCD device 120 in the fifth and sixth embodiments respectively. Compared to the third and fourth embodiments, the scan sequence of the pixel units is irregular in the fifth and sixth embodiments. However, each pixel unit still contains data with a polarity opposite to that of adjacent pixel units in the vertical and horizontal directions. Adjacent pixel units receiving data from the data driver 32 via different demultiplexers (e.g.: the pixel units Pₘ₁ of the data line DLₘ and the pixel units P₍ₘ₊₁₎₁ of the data line DLₘ₊₁) are also accessed simultaneously. Therefore, stray capacitance existing between these adjacent pixels units do not influence data written into the pixels. As a result, the present invention can reduce mura effect and thus provides high display quality. In a seventh embodiment of the present invention, the scan pulses A₁′-Aₘ′ and B₁′-Bₘ′ are respectively applied when accessing the pixel units coupled to the odd- and even-numbered gate lines of the LCD device 120 in the odd-numbered frame periods, while the scan pulses E₁′-Eₘ′ and C₁′-Cₘ′ are respectively applied when accessing the pixel units coupled to the odd- and even-numbered gate lines of the LCD device 120 in the even-numbered frame periods. In an eighth embodiment of the present invention, the scan pulses B₁′-Bₘ′ and A₁′-Aₘ′ are respectively applied when accessing the pixel units coupled to the odd- and even-numbered gate lines of the LCD device 120 in the odd-numbered frame periods, while the scan pulses C₁′-Cₘ′ and E₁′-Eₘ′ are respectively applied when accessing the pixel units coupled to the odd- and even-numbered gate lines of the LCD device 120 in the even-numbered frame periods. In the seventh and eight embodiments of the present invention, pixel units of a same gate line are scanned in different directions with respect to alternating frame periods.

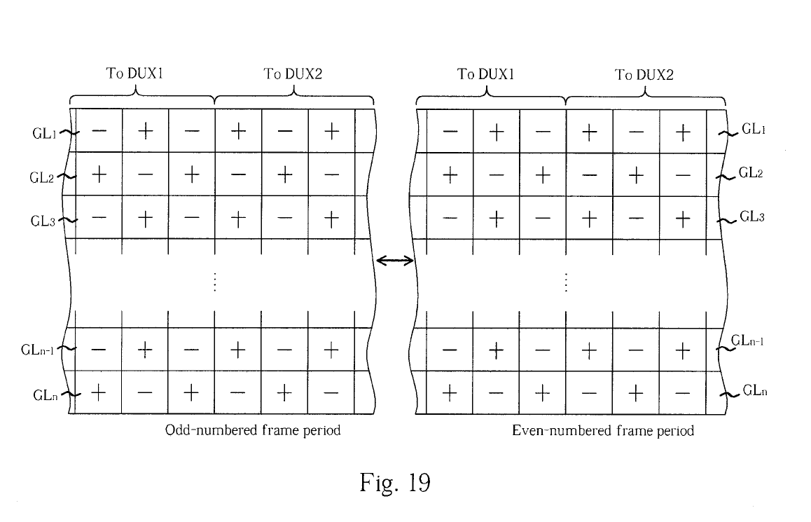

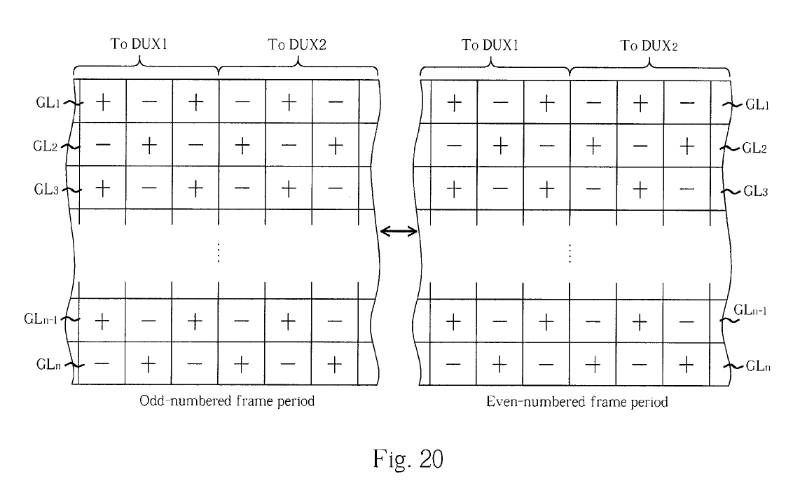

FIG. 19 and FIG. 20 are schematic diagrams showing the polarities of data written into the pixel units of the LCD device 120 in the seventh and eighth embodiments respectively. Compared to the third and fourth embodiments, the scan sequence of the pixel units is irregular in the seventh and eighth embodiments. However, each pixel unit still contains data with a polarity opposite to that of adjacent pixel units in the vertical and horizontal directions. Adjacent pixel units receiving data from the data driver 32 via different demultiplexers (e.g.: the pixel units Pₘ₁ of the data line DLₘ and the pixel units P₍ₘ₊₁₎₁ of the data line DLₘ₊₁) are also accessed simultaneously. Therefore, stray capacitance existing between these adjacent pixels units do not influence data written into the pixels. In addition, the scan direction of the same gate line changes with respect to alternating frame periods, which further reduces mura phenomenon in the LCD device 120 and can further improves display quality.

In the present invention, adjacent pixel units of the same gate line that receive data from the data driver via different demultiplexers are accessed simultaneously. Therefore, stray capacitance existing between these adjacent pixels units do not influence data written into the pixels and thereby reduces mura effect and improves display quality of the LCD.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for driving a display panel comprising:
when displaying a first frame, writing data with a first polarity into a first pixel unit of the display panel via a first demultiplexer and writing data with a second polarity into a second pixel unit adjacent to the first pixel unit via a second demultiplexer simultaneously, wherein the first and second pixel units are coupled to a first gate line, and the first polarity is opposite to the second polarity.

2. The method of claim 1 further comprising:
after writing data into the first and second pixel units, writing data with the second polarity into a third pixel unit adjacent to the first pixel unit via the first demultiplexer and writing data with the first polarity into a fourth pixel unit adjacent to the second pixel unit via the second demultiplexer simultaneously.

3. The method of claim 2 further comprising:
when displaying a second frame following the first frame, writing data with the first polarity into the third pixel unit of the display panel via the first demultiplexer and writing data with the second polarity into the fourth pixel unit of the display panel via the second demultiplexer simultaneously.

4. The method of claim 3 further comprising:
after writing data into the third and fourth displaying units when displaying the second frame, writing data with the second polarity into the first pixel unit of the display panel via the first demultiplexer and writing data with the first polarity into the second pixel unit of the display panel via the second demultiplexer simultaneously.

5. The method of claim 2 wherein:
writing data with the second polarity into a third pixel unit adjacent to the first pixel unit via the first demultiplexer is writing data with the second polarity into a third pixel unit adjacent to the first pixel unit and coupled to the first gate line via the first demultiplexer; and:
writing data with the first polarity into a fourth pixel unit adjacent to the second pixel unit via the second demultiplexer simultaneously is writing data with the first polarity into a fourth pixel unit adjacent to the second pixel unit and coupled to the first gate line via the second demultiplexer simultaneously.

6. The method of claim 2 wherein:
writing data with the second polarity into a third pixel unit adjacent to the first pixel unit via the first demultiplexer is writing data with the second polarity into a third pixel unit adjacent to the first pixel unit and coupled to a second gate line via the first demultiplexer; and
writing data with the first polarity into a fourth pixel unit adjacent to the second pixel unit via the second demultiplexer simultaneously is writing data with the first polarity into a fourth pixel unit adjacent to the second pixel unit and coupled to the second gate line via the second demultiplexer simultaneously.

7. The method of claim 6 further comprising:
after writing data into the third and fourth displaying units, writing data with the first polarity into a fifth pixel unit adjacent to the third pixel unit and coupled to the second gate via the first demultiplexer and writing data with the second polarity into a sixth pixel unit adjacent to the fourth pixel unit and coupled to the second gate via the second demultiplexer simultaneously.

8. The method of claim 6 further comprising:
before writing data into the third and fourth displaying units, writing data with the first polarity into a fifth pixel unit adjacent to the third pixel unit and coupled to the second gate via the first demultiplexer and writing data with the second polarity into a sixth pixel unit adjacent to the fourth pixel unit and coupled to the second gate via the second demultiplexer simultaneously.

9. The method of claim 1 further comprising:
when displaying a second frame following the first frame, writing data with the second polarity into the first pixel unit of the display panel via the first demultiplexer and writing data with the first polarity into the second pixel unit of the display panel via the second demultiplexer simultaneously.

10. The method of claim 1 further comprising:
before writing data into the first and second displaying units, writing data with the second polarity into a third pixel unit adjacent to the first pixel unit and coupled to the first gate via the first demultiplexer and writing data with the first polarity into a fourth pixel unit adjacent to the second pixel unit and coupled to the first gate via the second demultiplexer simultaneously.

11. The method of claim 10 further comprising:
when displaying a second frame following the first frame, writing data with the second polarity into the first pixel unit of the display panel via the first demultiplexer and writing data with the first polarity into the second pixel unit of the display panel via the second demultiplexer simultaneously.

12. The method of claim 11 further comprising:
after writing data into the first and second displaying units when displaying the second frame, writing data with the first polarity into the third pixel unit of the display panel via the first demultiplexer and writing data with the second polarity into the fourth pixel unit of the display panel via the second demultiplexer simultaneously.

13. The method of claim 1 further comprising:
after writing data into the first and second displaying units, writing data with the first polarity into a third pixel unit not adjacent to the first pixel unit via the first demultiplexer and writing data with the second polarity into a fourth pixel unit not adjacent to the second pixel unit via the second demultiplexer simultaneously wherein the third and fourth pixel units are coupled to the first gate line.

14. The method of claim 1 further comprising:
after writing data into the first and second displaying units, writing data with the second polarity into a third pixel unit not adjacent to the first pixel unit via the first demultiplexer and writing data with the first polarity into a fourth pixel unit not adjacent to the second pixel unit via the second demultiplexer simultaneously, wherein the third and fourth pixel units are coupled to the first gate line.

15. A system for displaying images comprising:
a gate line;
a first pixel unit coupled to the gate line;
a second pixel unit adjacent to the first pixel unit and coupled to the gate line;
a first demultiplexer coupled to the first pixel unit;
a second demultiplexer coupled to the second pixel unit; and
means for writing data with a first polarity into the first pixel unit via the first demultiplexer and writing data with a second polarity into the second pixel unit via the second demultiplexer simultaneously when displaying a first frame, wherein the first polarity is opposite to the second polarity.

16. The system of claim 15 further comprising:
a gate driver coupled to the gate line for sending control signals to the gate line.

17. The system of claim 15 further comprising:
a first data line coupled to the first pixel unit;
a second data line coupled to the second pixel unit and adjacent to the first data line; and
a source driver coupled to the first and second data lines for outputting data to be written into the first and second pixel units.

18. The system of claim 17 wherein the first demultiplexer is coupled between the first data line and the source driver, and the second demultiplexer is coupled between the second data line and the source driver.

19. The system of claim 17 wherein the first demultiplexer comprises:
a first switch coupled between the first pixel unit and the source driver; and
a second switch coupled between the second pixel unit and the source driver.

20. The system of claim 19 further comprising a control circuit coupled to the first and second demultiplexers for turning on or turning off the first and second switches.
